(19) United States
(12) Patent Application Publication
(10) Pub. No.: US 2025/0292155 A1
(43) Pub. Date: Sep. 18, 2025

(54) INTERACTIVE DIGITAL LEGACY SYSTEM AND METHOD

(71) Applicant: Michael B. Weiss, Buckeye, AZ (US)

(72) Inventors: Michael B. Weiss, Buckeye, AZ (US); Robert Frederick, Seattle, WA (US)

(21) Appl. No.: 19/079,354

(22) Filed: Mar. 13, 2025

Related U.S. Application Data
(60) Provisional application No. 63/565,111, filed on Mar. 14, 2024.

(51) Int. Cl. G06N 20/00

(52) U.S. Cl. CPC G06N 20/00

(57) ABSTRACT

A system and method for generating an AI-powered interactive digital legacy avatar that enables multi-modal interaction posthumously. The system allows users to store and upload digital assets, such as text, audio, video, and images, which are processed using AI-driven models, including machine learning (ML) and natural language processing (NLP), to create a personalized avatar. The system integrates privacy control, multi-generational inheritance, emotion-responsive AI features, and blockchain-based authentication to ensure secure digital legacy preservation. Users and authorized heirs can interact with the avatar via text, voice, video, and augmented/virtual reality (AR/VR) interfaces.

### RELATED APPLICATIONS

This application claims the benefit of U.S. Provisional Patent Application No. 63/565, 111, filed Mar. 14, 2024, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to a framework, system, and method of artificial intelligence avatars, including a system and method that trains and implements avatars that replicate the personality of a particular person to preserve their memory and legacy.

### BACKGROUND

In the age of digital information, there is a growing need for individuals to preserve their legacy and memories in a manner that can be interactively accessed by future generations. Current digital memorialization methods of preserving memories are largely passive, consisting of archived photos, video recordings, written diaries, and photo albums. However, these methods lack interactivity and the ability to provide a real-time, conversational experience with the individual's persona. While some AI-based chatbots and virtual assistants attempt to replicate a user's conversational patterns, they lack the personalization, adaptive learning, and secure inheritance mechanisms necessary to function as a true digital legacy system. Numerous attempts have been made to address these problems, however, each of them has drawbacks.

U.S. Pat. No. 10,853,717 to Abramson describes an artificial intelligence (AI) chatbots trained on personal data, designed for real-time conversational engagement, enhancing user interaction by simulating the specific person's responses and conversations use pre-recorded data, but lacks interactive, multi-modal avatars with emotion-responsive Al of an interactive digital legacy system incorporating a broader spectrum of personal data, including biometric information and multimedia content, to construct a dynamic, ongoing and evolving digital representation of the individual that preserve and emulate the unique personality and memories of an individual, extending beyond real-time conversations to maintain a lasting digital presence as described herein.

U.S. Pat. No. 10,796,480 to Chen describes static three-dimensional (3D) model to generate accurate 3D models of a user's head or body for applications like virtual clothing fitting, gaming, or personalized media, but does not enable AI-driven, personality-emulating conversations enabling posthumous interactions with loved ones of an interactive digital legacy system as described herein.

U.S. Pat. No. 10,649,988 to Gold describes backend AI processing system but does not describe aspects of an interactive digital legacy system or personality modeling to create AI-driven avatars for enabling continuous and evolving posthumous interaction with loved ones, as described herein.

U.S. Pat. No. 11,062,616 to Chakraborty describes a real-time adaptive educational content delivery, and does not describe aspects of an AI-driven interactive digital legacy system as described herein that focuses on personalization based on pre-existing data rather than real-time adaption,

U.S. Pat No. 11,580,350 to Wu describes a chat bot with a focus on using immediate real-time user input interpreting and responding to user's emotions during interactions, primarily for customer service, virtual assistance, or general user engagement. However, Wu does not describe aspects of an interactive digital legacy system as described herein that incorporates extensive personal data, including historical interactions and multimedia content to construct a dynamic and evolving digital representation of a specific individual and creating an ongoing personalized digital legacy allowing for enabling continuous and evolving posthumous interactions with loved ones, extending beyond real-time assistance to maintain a lasting digital presence.

U.S. Pat No. 10,733,496 to Wu describes a platform for users to engage in conversational entities with AI entities which may serve various functions such as virtual assistants, customer service agents or entertainment personas. However, Wu does not describe aspects of an interactive digital legacy system incorporating extensive personal data including images, voice recordings, textual memories and biometric information to construct a highly personalized and dynamic digital representation of an individual allowing for enabling continuous and evolving posthumous interactions with loved ones, as described herein.

U.S. Pat No. 20170256257 of Froelich describes creating a versatile conversational software agent capable of assisting users with a variety of tasks, such as scheduling or information retrieval enhancing user productivity and providing immediate support through natural language processing (NLP). However, Froelich does not describe aspects of an interactive digital legacy system as described herein by generating AI avatars incorporating extensive personal data that replicate an individual's unique characteristics, enabling continuous and evolving posthumous interactions with loved ones.

U.S. Pat No. 11,921,782 to Duan describes a video chat system designed to improve the user experience during video calls by providing real-time tools for personalization and engagement. However, Duan does not describe aspects of an interactive digital legacy system as described herein, that creates personalized AI avatars incorporating extensive personal data and replicates an individual's likeness and personality, enabling continuous and evolving posthumous interactions with loved ones through various mediums, including video

U.S. Pat No. 8,847,956 to Belt describes a method for real-time modifying a digital image by incorporating current characteristics detected from a user to enhance personalization. However, Belt does not describe aspects of an interactive digital legacy system as described herein that incorporates extensive personal data to create comprehensive AI avatars that replicate an individual's likeness and personality, enabling continuous and evolving posthumous interactions with loved ones

U.S. Pat No. 11,423,066 to Ganu describes a system that addresses real-time ambiguous queries from a user to a chat bot to refine the query's context enabling the chatbot to provide more accurate and relevant responses However, Ganu does not describe aspects of an interactive digital legacy system as described herein, that creates personalized AI avatars incorporating extensive personal data, including images, voice recordings, and textual memories, that replicate an individual's likeness, unique personality and memories, enabling ongoing and evolving posthumous interactions with loved ones

U.S. Pat No. 11,922,515 to Lombard describes methods and apparatuses designed to enhance the functionality of an AI digital assistant that communicates using a learned communication style potentially enhancing their responsiveness, contextual understanding, or user engagement. However, Lombard does not describe aspects of an interactive digital legacy system as described herein that creates personalized AI avatars incorporating extensive personal data, including images, voice recordings, and textual memories, that preserve and emulate an individual's likeness, unique personality and memories, enabling ongoing and evolving posthumous interactions with loved ones.

There is a need for a system that creates and implements a digital avatar that may be trained using personal information from a particular user (and/or from others who may intimately know the particular user) such that the avatar may replicate the personality, mannerisms, emotional traits, and overall characteristics of a particular person, e.g., a loved one, making it possible for users to communicate with the essence of the loved one once he/she has passed away.

### SUMMARY

The present invention relates to an AI-powered interactive digital legacy system and method that enables individuals to create and interact with a multi-modal, evolving digital twin capable of preserving their likeness, personality, and memory posthumously or otherwise. The system utilizes machine learning (ML), natural language processing (NLP), and artificial intelligence (AI) to synthesize user-provided data—including voice recordings, images, textual narratives, and biometric inputs—into a lifelike AI persona.

The system includes a dynamically interactive AI-driven digital avatar that learns and refines its responses over time. The system also may include a multi-generational digital inheritance system, ensuring controlled, private access across authorized users. The system also may include sentiment-adaptive AI modeling, enabling the avatar to adjust speech, tone, and expressions based on user interactions, real-time user engagement across text, voice, and AR/VR environments, providing an immersive experience beyond conventional chatbots. The system also may include a privacy-controlled authentication system, incorporating blockchain-based verification and multi-factor authentication to ensure data security and access control.

The interactive digital legacy system serves as a secure and innovative platform for preserving an individual's legacy in a highly personalized and interactive manner. Through AI-powered memory refinement and contextual adaptation, the system continuously enhances conversational depth, emotional intelligence, and response accuracy. The invention further enables digital identity succession, allowing pre-authorized individuals to inherit and manage the AI persona through a smart contract-based access control mechanism.

According to one aspect, one or more embodiments are provided below for an interactive digital legacy system and method. The method may include acquiring first data pertaining to a first person, analyzing at least some of the first data to determine a first personality characteristic of the first person, generating first training data using the first data and the first personality characteristic of the first person, training a personality characteristic machine learning model using the first training data, determining, using the personality characteristic machine learning model, a first response reflecting the first personality characteristic of the first person, and providing the first response to a user.

In another embodiment, the first data includes at least one of textual data, audio data, and visual data.

In another embodiment, the method includes analyzing at least some of the first data to determine a first context relating to a first prior experience of the first person, wherein the first response reflects the first context.

In another embodiment, the method includes receiving, from the user, second data pertaining to the first person, wherein the second data is provided as a second response from the user in response to the first response.

In another embodiment, the method includes adding the second data to the first data to form third data pertaining to the first person, analyzing at least some of the third data to determine a second personality characteristic of the first person, modifying the first training data using the third data to create second training data, and retraining the personality characteristic machine learning model using the second training data.

In another embodiment, the method includes determining, using the retrained personality characteristic machine learning model, a third response reflecting the second personality characteristic of the first person, the third response in response to the second response, and providing the third response to the user.

In another embodiment, the first response includes a first audio response that mimics an audio characteristic of the first person's voice.

In another embodiment, the audio characteristic includes a tone quality of the first person's voice.

In another embodiment, the first response includes a first visual response that mimics a visual characteristic of the first person.

In another embodiment, the visual characteristic includes a visual characteristic of a facial feature of the first person.

In another embodiment, the first response includes a first textual response that mimics a vocabulary characteristic of the first person.

According to another aspect, one or more embodiments are provided below for a platform-agnostic digital avatar apparatus for electronic communication with a user. The apparatus may include a processor, and a memory, wherein the memory is electronically and communicatively coupled with the processor and storing instructions configuring the processor to acquire first data pertaining to a first person, extract at least one first person datum from the first data, and determine a personality characteristic from the at least one first person datum, wherein determining the personality characteristic further comprises analyzing the at least one first person datum to determine a first personality characteristic, generating first personality characteristic training data based on the first personality characteristic, wherein the first personality training data comprises correlations between exemplary personality elements which correspond to the first personality characteristic, wherein the first personality characteristic training data is labeled in accordance with the first personality characteristic, training a personality characteristic machine learning model using the first personality characteristic training data, wherein the model is configured to generate a dynamic response reflecting the determined personality characteristic, and determining, using the personality characteristic machine learning model, an appropriate natural language response reflecting the first personality characteristic, wherein the response is a function of the personality elements, modify the first data based on at least one of the first user datum and the first data, and transmit a first response as a function of the appropriate natural language response and the first personality characteristic to the user.

In another embodiment, the first data includes at least one of textual data, audio data, and visual data.

In another embodiment, the processor is further configured to analyze at least some of the first data to determine a first context relating to a first prior experience of the first person, wherein the first response reflects the first context.

In another embodiment, the processor is further configured to receive, from the user, second data pertaining to the first person, wherein the second data is provided as a second response from the user in response to the first response.

In another embodiment, the processor is further configured to add the second data to the first data to form third data pertaining to the first person, extract at least one second person datum from the third data, analyze the at least one second person datum to determine a second personality characteristic of the first person, generate second personality characteristic training data based on the second personality characteristic, and retrain the personality characteristic machine learning model using the second training data.

In another embodiment, processor is further configured to determine, using the retrained personality characteristic machine learning model, an appropriate natural language response reflecting the second personality characteristic, and transmit a second response as a function of the appropriate natural language response and the second personality characteristic to the user.

In the following discussion, a general description of the system and its components is provided, followed by a discussion of the operation of the same.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of an interactive digital legacy system in accordance with exemplary embodiments hereof;

FIG. 2 shows actions taken by an interactive digital legacy system and/or a user of such system in accordance with exemplary embodiments hereof;

FIG. 3 shows actions taken by an interactive digital legacy system in accordance with exemplary embodiments hereof;

FIG. 4 shows actions taken by an interactive digital legacy system in accordance with exemplary embodiments hereof;

FIG. 5 shows actions taken by an interactive digital legacy system and/or a user of such system in accordance with exemplary embodiments hereof;

FIG. 6 shows ways in which a user may interact with an avatar in accordance with exemplary embodiments hereof;

FIG. 7 shows aspects of an interactive digital legacy system in accordance with exemplary embodiments hereof; and

FIG. 8 depicts aspects of computing and computer devices in accordance with exemplary embodiments hereof.

### DETAILED DESCRIPTION OF EXEMPLARY EMBODIMENTS

The current invention generally includes a system and method of creating and interacting with personalized lifelike digital avatars. The digital avatars may be created to directly replicate the personality, mannerisms, emotional traits, and overall characteristics of a particular person, e.g., a loved one. Once a digital avatar is created for a particular person, others may interact with the digital avatar with the experience of having interacted with the actual person themselves.

As such, the inventive system and method provides a platform where users can create lifelike digital avatars of themselves (or of loved ones) that may preserve and embody their personal memories, experiences, emotional characteristics, wisdom, and overall legacies that others (e.g., family members, friends, and future generations, etc.) may interact with even after the person may have passed. In this way, the legacy of the person may be preserved and available to interact with for generations to come.

In general, the interactive digital legacy system 10 and method described herein provides functionalities to (i) create, (ii) implement, (iii) utilize, and (iv) continually update one or more interactive digital avatars 12 based on a persona of an actual person P. The interactive digital legacy system 10 also may be referred to herein as the legacy system 10 or simply as the system 10.

For the purposes of this specification and for the understanding of the interactive digital legacy system 10 and its functionalities, the system 10 and the method of its creation and use will be described primarily in relation to individuals and/or families who wish to use the system 10 to create and interact with personalized digital avatars 12 of loved ones, e.g., loved ones nearing the end of life. In this way, once the loved one passes, the memories and experiences of the loved one are preserved and available through interaction with the digital avatar 12 thereby providing a continuing heartfelt experience. It is understood, however, by a person of ordinary skill in the art, that the system and method of the current invention also may be applied to other types of potential users for other potential purposes. For example, the system 10 may be used as an interactive educational tool, a virtual assistant, a digital counselor, a digital entertainment personality, etc. It is also understood that the scope of the system 10 is not limited in any way by how the system 10 may be used and/or what type(s) of digital personalities that may be created and implemented using the system 10.

In some embodiments, the system 10 includes a platform-agnostic artificial intelligent (AI) system that may receive data pertaining to the actual person P and that may utilize this data to train an artificial intelligence entity (e.g., the interactive digital avatar 12) that may then emulate the person P.

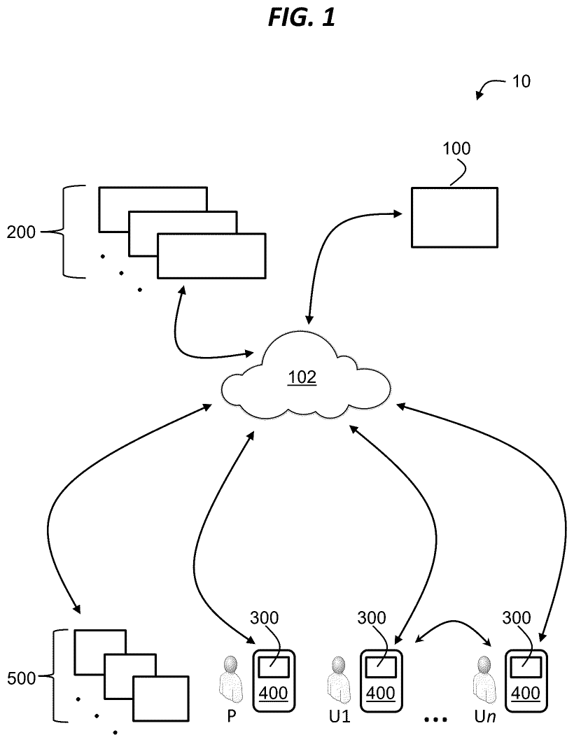

FIG. 1 shows an overview of a generalized framework for an interactive digital legacy system 10 according to exemplary embodiments hereof.

As shown, the digital legacy system 10 may include a backend controller 100 that may be accessed by the actual person P and multiple users U1, U2, . . . Un (e.g., via the network 102, as described below) using one or more application interfaces 300 (e.g., a mobile application or “app”, a browser, website or Internet interface, or other types of applications) running on one or more computing devices 400 (e.g., smart phones, tablet computers, laptops, desktop computers, mobile media players, augmented reality (AR) devices, virtual reality (VR) devices, gaming consoles, etc.). The system 10 may also communicate with various external systems 500 (e.g., funeral homes, memory preservation services, end-of-life services, other external databases, etc.). The system 10 is preferably platform agnostic.

The user interface(s) 300 and backend controller 100 may be connected to one or more networks 102 (e.g., in any combination, the Internet, LAN, WAN, etc.), wireless communication systems, cellular communication systems, satellite communication systems, telephony and/or other types of communication systems or protocols.

In some embodiments, each application 300 may include a graphical user interface (GUI) that enables the person P and each user Un to interact with the system 10 during use of the system 10.

In some embodiments, the backend controller 100 may include a cloud platform (e.g., one or more backend servers with secure data storage systems), one or more local controllers, or any combination thereof. In some embodiments, the backend controller 100 includes a cloud platform that interfaces with one or more local controllers. For example, users Un of the system 10 may interface with the system 10 via a local controller in communication to a cloud platform. In some embodiments, all or some elements of the system 10 may run on a cloud server, may be provided in a downloadable format to run on a local controller, and/or any combinations thereof.

In some embodiments, the backend controller 100 may interface with external systems 200 (e.g., social networks, websites, blogs, external databases, etc.) to gather, collect, organize, and/or generally aggregate information to be utilized by the system 10.

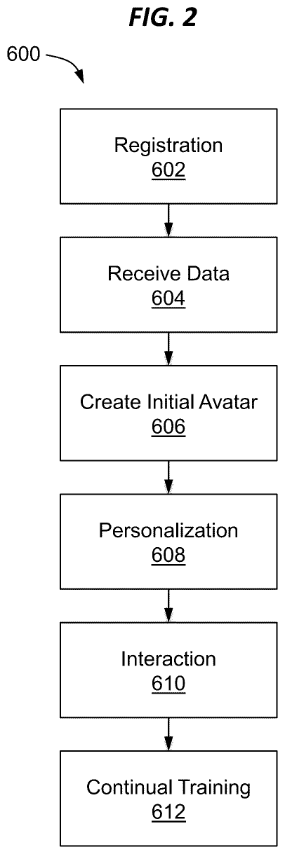

FIG. 2 shows generally high-level actions 600 that may be taken by the system 10 and/or by the person P or a user Un of the system 10 to during operation of the system 10 (e.g., to create an interactive avatar 12).

At 602, the person P or user Un may generally register with the system 10, e.g., create a user account that provides the person P and/or the user Un secure access to the system 10 and its functionalities.

At 604, the system 10 may receive or otherwise acquire data (e.g., pertaining to the person P), and at 606 the system 10 may create an initial interactive digital avatar 12 based on the received data.

Once the initial digital avatar 12 has been created, the system 10 may provide additional tools to the person P or user Un to further personalize and customize the digital avatar 12 (at 608). For example, the system 10 may provide tools to customize the appearance of the digital avatar 12.

At 610, the person P and/or other users Un may begin interacting with the avatar 12 which may provide a feedback loop (at 612) that provides additional ongoing training of the avatar 12 as described in other sections.

In some embodiments, ownership of and/or the rights to interact with a particular avatar 12 may be passed from one or more approved and/or credentialed users Un to other users Un, e.g., from generation to generation, in order that the avatar 12 may be implemented in perpetuity or as otherwise desired. In some embodiments, this secure transfer of rights may occur via blockchain or smart contracts.

It is understood that the example actions described above are meant for demonstration and that other actions also may be taken, not all of the actions must necessarily be taken, and the actions may be taken in different order.

Further details of each of these actions 600 will be described next.

### Data Acquisition

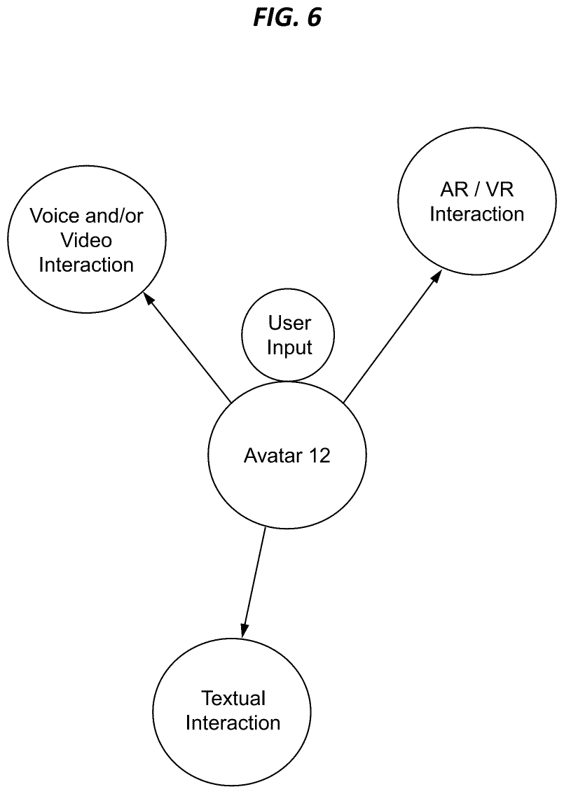

In some embodiments, the person P and/or a user Un may provide user profile data to the system 10 through the use of the application 300 (e.g., a mobile app, website, etc.) running on or otherwise available via a computing device 400 (e.g., a smartphone, tablet computer, laptop, etc.). The application 300 may include a graphical user interface (GUI) that enables the person P and each user Un to enter his/her profile information to be captured, uploaded, and stored to the system databases. In some embodiments, a data intake application 108 (see FIG. 6) may facilitate the capturing and storing of the user profile data into the user profile database 124.

In some embodiments, the system 10 may collect or otherwise acquire data (also referred to as training data) pertaining to the person P. The training data may include one or more data sets that may be carefully chosen to reflect the desired physical appearance, personality traits, and other characteristics that embody the intended personality of the person P. The data may be stored in one or more system databases as described in other sections.

This data may be provided in a variety of formats. For example, the input data may include visual data (e.g., photographs, videos, graphics, etc.), audio data (e.g., voice and speech recordings), textual data (e.g., linguistically relevant characters, words, sentences, etc.), other types of data, and/or any combinations thereof (multimedia).

In general, visual data may be used to replicate the physical appearances of the avatar 12 to resemble (and preferably match) that of the person P. This may include the facial features and hair style of the person P, body types, the type(s) of clothing that the person P may typically wear, and other physical characteristics.

In addition, audio data may be parsed by the system 10 to interpret and understand the contextual meaning of the spoken words, and also may be used to replicate the sound, tone, and nuances of the person's P's voice. Textual data may be interpreted for contextual meaning to be used for replicating the person's P's personally and behavioral characteristics, etc.

In some embodiments, the system 10 may collect or otherwise receive the data in a variety of ways. For example, the data may be input into the system 10 (e.g., uploaded, scanned, typed, etc.) by the person P (and/or by other users Un who preferably may know the person P). The person P or users Un may utilize the application 300 (e.g., the application's GUI) to upload one or more images and/or videos, written text (e.g., stories or experiences), email threads, text threads, voice recordings (e.g., of stories or experiences) and/or other assets that may be used to create and train the digital avatar 12.

In some embodiments, the system 10 may communicate with (e.g., interface with via APIs or similar) and receive the data from external systems 200, e.g., social network account(s) used by the person P, blogs posted by the person P, articles written by the person P, photographs uploaded to image file sharing platforms, videos uploaded to video file sharing platforms, and/or other data sources.

In some embodiments, the system 10 may access assets directly from one or more communication accounts used by the person P, e.g., email threads from email accounts, text threads from text accounts, voice mails from voicemail accounts, message board threads from message board accounts, etc. Such data may include interactions between the person P and others that may reflect personality characteristics and beliefs of the person P and that may be used to further enrich and embellish the performance of the digital avatars 12.

In some embodiments, the system 10 may provide, e.g., through its application 300, one or more interactive wizards (via the GUI) that may guide the person P and/or the users Un through the data providing exercises.

In some embodiments, the system 10 may further guide the person P and/or the users Un through the data gathering and providing process by providing, e.g., through its application 300, one or more templates and/or questionnaires that may ask pertinent questions and that may subsequently receive replies from the person P and/or the users Un that may be added to the respective data sets. The questions may ask the person P or users Un for simple answers and/or may request detailed answers and/or explanations pertaining to events and/or experiences that the person P may have gone through during his/her lifetime. This process may resemble an interview-style of data gathering.

### Creating the Digital Avatar 12

In some embodiments, the digital avatar 12 includes an artificial intelligence (AI) entity that is trained using the data received as described herein.

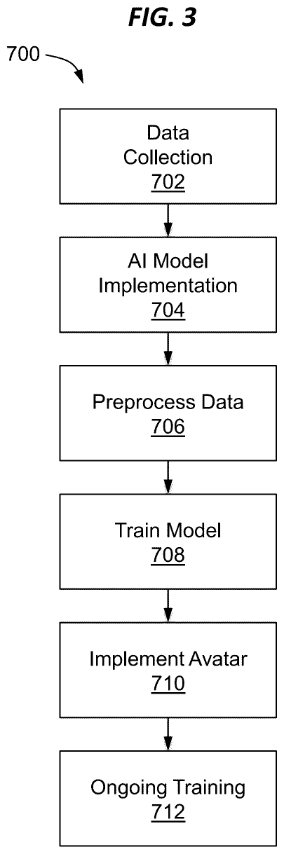

FIG. 3 shows actions 700 that the system 10 may take while creating the interactive digital avatar 12.

At 702, the training data may be produced and/or acquired by the system 10 as described herein.

At 704, the system 10 may choose one or more appropriate AI model(s) (including appropriate algorithms) to utilize based on the desired results.

At 706, the data may be pre-processed for consistency and to clean and format the data into suitable formats for the AI model(s) being used. Labels also may be added to the data and/or the data may be tokenized.

At 708, the system 10 may train the model(s) using the pre-processed data from 706, and at 710, the system 10 may implement the AI models as the digital avatar 12.

Once implemented, the interactive digital avatar 12 may be continually trained (at 712) using new data gleaned from interactions between the avatar 12 and the person P and/or the users Un, as well as by using additional data acquired by the system 10 (e.g., additional data uploaded to the system 10, acquired from other systems such as social networks, etc.) after its initial implementation. This process may be ongoing indefinitely and/or as desired.

Further details of each of these actions 700 will be described next.

In some embodiments, the system 10 may implement conversational AI that may simulate human conversation. As such, the system 10 may utilize a combination of several AI technologies such as speech recognition technologies to transcribe speech to text, as well as foundation models, natural language processing (NLP) and machine learning (ML) to interpret the meaning of the text and to generate a response.

In some embodiments, the responses may preferably be converted into and provided as spoken word, however, other formats such as textual responses also may be utilized. As such, the system 10 may implement automatic speech recognition (ASR), audio intelligence, and large language models (LLMs) (see below). In some embodiments, the system 10 is trained to replicate (e.g., to synthesize) the vocal patterns, intonations, and nuances of the person's P's voice such that the generated spoken words resemble (and preferably match) the voice of the person P.

In some embodiments, the system 10 also may implement large language models (LLMs) or similar transformer-based architectures that may enable the resulting digital avatar 12 to generate coherent, human-like, and contextually relevant responses based on the personality and life history of the person P.

In some embodiments, the system 10 may utilize facial recognition engines to recognize, record, and interpret the facial features of the person P shown in the images and videos acquired by the system 10, as well as of the facial features of the person P during live interactions with the person P, e.g., via a camera associated with the electronic device 400 being used.

In some embodiments, the system 10 may utilize generative adversarial networks (GANs) that may include machine learning models (ML) including deep neural networks comprised of two competing neural networks (e.g., a generator and a discriminator) for creating a visual appearance of the digital avatar 12 that may resemble that of the person P. The system 10 may train a generator network using a diverse dataset of facial expressions of the person P (e.g., images and/or videos of the person P exhibiting different facial expressions) to generate different emotions, such as happiness, sadness, anger, surprise, etc. The visual assets may be categorized and/or labeled to match the emotional context of each respective asset. The resulting generated facial expressions may be fine-tuned using a discriminator network and may then be implemented as animated avatars 12 and/or by blending the generated facial expressions with original images or videos of the person's P′s face for human-looking implementations.

In some embodiments, during implementation of the generated facial expressions of the avatar 12 during an interaction with the person P or a user Un, the system 10 may perceive in real time an emotional context of the interaction and apply in real time the appropriate facial expression(s) to match the context. That is, the system 10 may continually interpret the tone and content of the interactions between the digital avatar 12 and a user Un to implement the appropriate facial expressions and voice tones in real time, making conversations with the avatar 12 lifelike and emotionally resonant. This may be referred to as emotion AI.

In some embodiments, the system 10 may implement trait theory (also referred to as dispositional theory). As known, trait theory includes an approach to the study of human personality involving the measurement of traits, which can be defined as habitual patterns of behavior, thought, and emotion. According to this perspective, traits may include aspects of personality (e.g., exemplary personality elements) that are relatively stable over time, that differ across individuals (e.g., some people are outgoing whereas others are not), that are relatively consistent over situations, and that influence a person's behavior.

In some embodiments, the system 10 may implement trait theory including the Big Five personality traits (also referred to as the five-factor model of personality) that may consolidate personality types into five exemplary personality elements:
1. Openness to experience, intellect, or imagination (e.g., imaginative/philosophical vs. uncreative/unintellectual);
2. Conscientiousness (efficient/organized vs. haphazard/careless);
3. Extraversion or surgency (bold/energetic vs. shy/bashful);
4. Agreeableness (sympathetic/cooperative vs. cold/harsh); and
5. Neuroticism or low emotional stability (moody/nervous vs. relaxed/calm).

It is understood that other trait models and/or personality models, and/or other exemplary personality elements may be used.

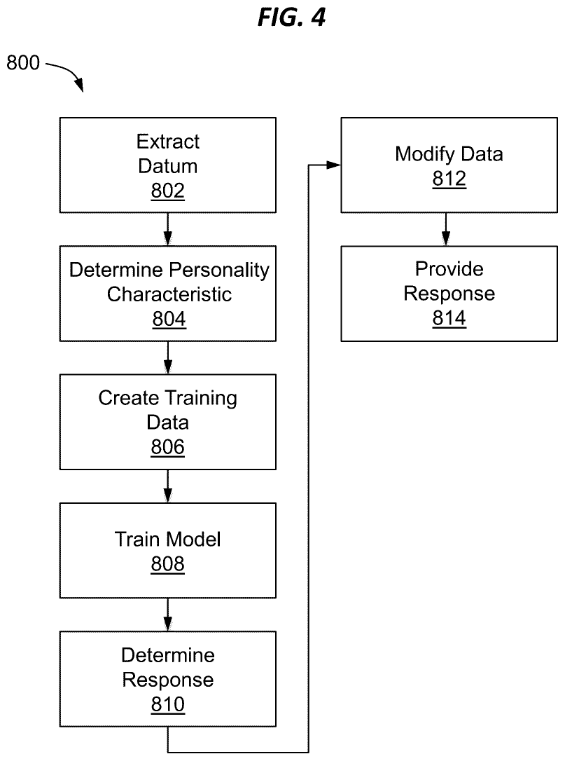

FIG. 4 shows actions 800 that the system 10 may take for such an implementation.

At 802, the system 10 may extract at least one person P datum from the data pertaining to the person P. “User datum,” as used herein, is defined as an element of information related to the person P. The system 10 may then analyze the at least one person P datum to determine at least one personality characteristic of the person P (at 804).

At 806, the system 10 may create or receive personality characteristic training data using the at least one personality characteristic, the at least one user datum, and/or the data pertaining to the particular person P. The personality characteristic training data preferably contains associations and/or correlations between known personality elements (e.g., exemplary personality elements) and one or more personality characteristics of the particular person P. The personality characteristic training data may be labeled in accordance with the first personality characteristic.

At 808, the system 10 may then train the applicable machine learning model using the personality characteristic training data. In some embodiments, the machine learning model may be trained using only the personality characteristic training data, while in other embodiments, other applicable training data also may be used in combination. The machine learning model may be referred to as a personality characteristic machine learning model.

At 810, the system 10 may next determine an appropriate response (e.g., a natural language response) reflecting the first personality characteristic. The response may be a function of the correlated personality elements.

At 812, the system 10 may modify the first data pertaining to the person P based at least on the at least one person datum and the first data. The system 10 then may provide a response (at 814) as a function of the appropriate response and the first personality characteristic to the user.

It is understood that any combinations of the above-described AI systems and/or techniques may be used to create a dynamic digital avatar 12 able to intelligently engage in meaningful interactions that reflect the person's P's personality, behavioral characteristics, and emotional nuances.

In some embodiments, once the initial digital avatar 12 is created and implemented, the person P and/or the users Un may begin conversationally interacting with the avatar 12 which may result in further training of the avatar AI engines.

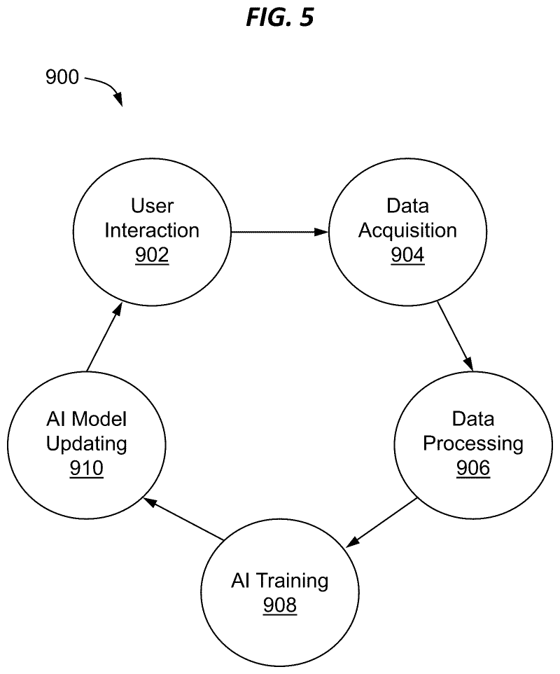

For example, FIG. 5 shows actions 900 that the system 10 may take as the person P and/or users Un interact with the implemented avatar 12 to further train the avatar 12.

At 902, the person P and/or user Un may interact with the avatar 12, and at 904 the system 10 may acquire the data from the interactions.

At 906 the system 10 may pre-process the acquired data in preparation for further training of the AI avatar 12 with the additional data, and at 908 the system 10 may then use the data to further train the AI avatar 12. At 910 the system 10 may update the avatar 12 accordingly and the further trained avatar 12 may be re-implemented for use. In this way, the person P and/or the users Un may interact with the further trained avatar 12 again at 902. This overall process preferably happens in real time (or near real time) so that the avatar 12 may be further trained and re-implemented in parallel with on-going interactions. This process may continue in perpetuity and/or as long as desired.

It also is understood that at any time throughout this process, the person P and/or the users Un also may continually provide additional training assets (e.g., uploading new images, videos, stories and memories, experiences, etc.) to further train the avatar 12 as described in other sections.

Additionally, in some embodiments, during such interactions between the avatar 12 and the person P, it may be preferable that the person P identify himself/herself so that the system 10 understands that it is interacting with the person P directly. In this case, as the system 10 receives the interactions (e.g., conversational voice or textual data), the interactions may be stored, preprocessed, classified, and/or otherwise prepared for use as continual training data that may be used to further refine the AI model(s) and to improve the similarities between the avatar 12 and the person P.

In some embodiments, the avatar 12 may enter into an interview-style process of gathering data that may result in a conversation with the person P about one or more particular experiences. For example, the avatar 12 may ask the person P to embellish on the details of a specific experience that the person P had previously provided to the system 10. In this example, the system 10 may analyze the initial data pertaining to the experience and may ask intelligent questions to the person P that may provide additional emotional and/or mindset information regarding the experience. For example, the avatar 12 may ask how a particular experience made the person P feel, how the person P dealt with the emotions, and what the person P may have learned from the experience. Once the answers are received, the new data may be used to refine the avatar model accordingly.

Similarly, during interactions between the avatar 12 and users Un other than the person P, the avatar 12 may ask the users Un questions pertaining to their experiences with the person P, e.g., how the person P acted during different experiences, what advice or wisdom the person P may have provided during different experiences, etc. Once the answers are received, the new data may be used to refine the avatar model accordingly.

In some embodiments, during such interactions between the avatar 12 and a user Un, the user Un may respond to a statement made by the avatar 12 by telling the avatar 12 that the statement does not appropriately represent the person P. For example, a user Un may say “Uncle John wouldn't say that . . . ” (with Uncle John being the person P in this example). Once this correctional statement is made, the avatar 12 may be triggered to ask the user Un for further details regarding what the person P may say differently under the present circumstances, in what ways the avatar 12 may have misrepresented the person P, etc. The user Un may then provide this information and the system 10 may use the data to further train and update the avatar 12. In some embodiments, it may be preferable that only particular users Un (e.g., close family members) be credentialed to provide such corrections to the avatar 12 that may result in the additional training such that only those who know or knew the person P on an intimate basis may have the authority for this type of training to occur.

Given the information above, it is preferable that the resulting digital avatar 12 encompass the beliefs, values, ideals, convictions, views, opinions, principles, morals, ethics, positions, sentiments, standards, ideas, sentiments, wisdoms, quirks, feelings, behaviors, etc. of the person P.

It also is preferable that the avatar 12 use the same vocabulary of the person P, e.g., sayings, words, or phrases, etc. that the person P may typically use. This may be referred to as a vocabulary characteristic of the person P.

It also is preferable that the avatar 12 embody the sense of humor of the person P such that the avatar 12 may make jokes and other funny and/or entertaining remarks that may “sound like something the person P would say”.

It also is preferable that the avatar 12 embody the likes and dislikes of the person P, e.g., his/her favorite (and least favorite) sports teams, favorite types of entertainment such as music, television shows and/or movies, etc.

It is understood that the examples provided above are meant for demonstration and are non-limiting.

### Avatar Interactions

In some embodiments, the digital avatar 12 may interact with the person P and/or the users Un in a number of ways (multi-modal). For example, as shown in FIG. 5, the person P and/or a user Un may provide conversational input to the avatar 12 (e.g., any type of interaction such as voice, text, etc.), and the avatar 12 may interact with the person P and/or user Un via voice and/or video, text, within AR/VR environments, etc.

In some embodiments, the system 10 may present the avatar 12 as a two-dimensional (2D) or three-dimensional (3D) representation of the person P on a display of a computing device 400 (e.g., smart phone, tablet computer, laptop, desktop computer, mobile media player, etc.). In this case, the avatar 12 may be shown as an animation and/or as a life-like representation of the person P (e.g., of the shoulders and head/face of the person P, the full body of the person P, and/or any combinations thereof). In this scenario, the person P and/or the users Un may interact with the avatar 12 by speaking to the computing device 400, by typing a response into the computing device 400, and/or by using other communication techniques associated with the device 400.

In some embodiments, the system 10 may provide an augmented reality (AR) environment and/or a virtual reality (VR) environment within which the avatar 12 may reside. In this case, the person P and/or the users Un may enter into the AR and/or VR environment(s) (preferably three-dimensional) and interact with the avatar 12 accordingly. For AR environments, the person P and/or the users Un may utilize AR equipped devices 400 (e.g., smartphones, tablet computers, gaming consoles, etc.) and for VR environments, the person P and/or the users Un may utilize VR equipped devices such as VR goggles or similar. This may provide more immersive and engaging experiences.

### Applications and Databases

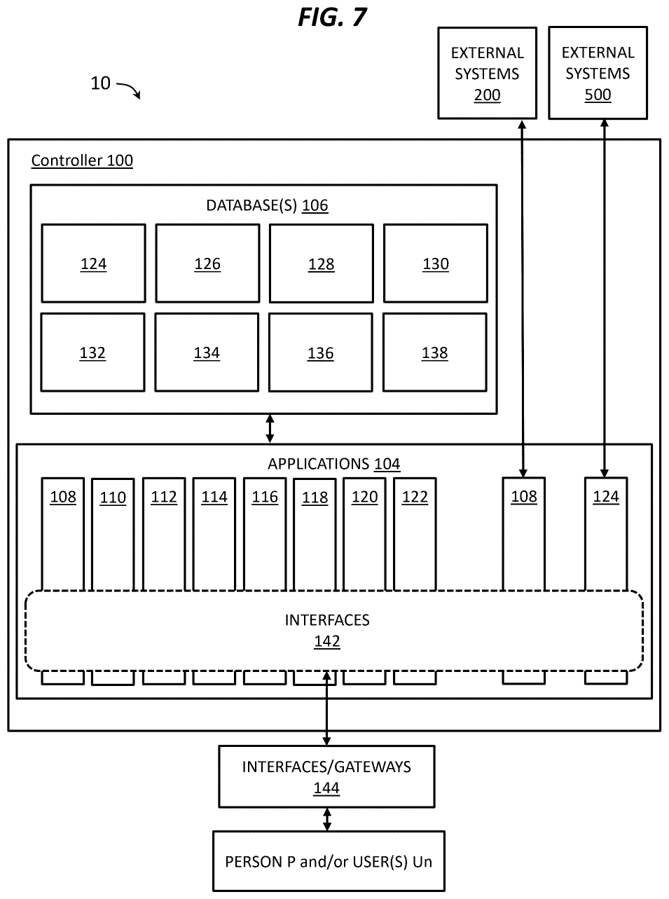

FIG. 7 shows aspects of an interactive digital legacy system 10 of FIG. 1. As shown in FIG. 6, the system 10 and backend system 100 comprises various internal applications 104 and one or more databases 106, described in greater detail below. The internal applications 104 may generally interact with the one or more databases 106 and the data stored therein.

The database(s) 106 may comprise one or more separate or integrated databases, at least some of which may be distributed. The database(s) 106 may be implemented in any manner, and, when made up of more than one database, the various databases need not all be implemented in the same way. It should be appreciated that the system is not limited by the nature or location of database(s) 106 or by the manner in which they are implemented.

Each of the internal applications 104 may provide one or more services via an appropriate interface. Although shown as separate applications 104 for the sake of this description, it is appreciated that some or all of the various applications 104 may be combined. The various applications 104 may be implemented in any manner and need not all be implemented in the same way (e.g., using the same software languages, interfaces, or protocols).

In some embodiments, the applications 104 may include one or more of the following applications 104:
1. Person P and/or user Un registration application(s) 108
2. Data acquisition application(s) 110 via interface 300
3. Data acquisition application(s) 112 from interfacing with other systems 200
4. Data pre-processing application(s) 114
5. AI technologies application(s) 116
6. AI model training application(s) 118
7. Avatar implementation application(s) 119
8. On-going AI model training application(s) 120
9. Data reporting application(s) 122

The applications 104 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 106 may include one or more of the following databases:
1. Person P and/or user Un profile database(s) 124
2. Data acquisition database(s) 126
3. Data pre-processing database(s) 128
4. AI technologies database(s) 130
5. AI model training database(s) 132
6. Avatar database(s) 134
7. On-going AI model training database(s) 136
8. Data report(s) database(s) 138

It is understood that the above list of databases is meant for demonstration and that the system 10 may include some or all of the databases, and also may include additional databases as required. It is also understood that the scope of the system 10 is not limited in any way by the databases that it may include.

Various applications 104 and databases 106 in the system 10 may be accessible via interface(s) 142. These interfaces 142 may be provided in the form of APIs or the like and made accessible to the person P and/or users Un via one or more gateways and interfaces 144 (e.g., via a web-based application 300 and/or a mobile application 300 running on a user's device 400).

In one exemplary embodiment hereof, each user Un that wishes to utilize the system 10 may provide user profile data to the system 10 (e.g., via the data intake application 108) and its databases 106 (e.g., user profile database 126).

In some embodiments, the applications and various elements of the system 10 may be reconfigurable while maintaining the system's core functionality. It also is understood that the Al algorithms may be updated as advancements may be available.

In some embodiments, the system 10 may be used for other applications, such as, but not limited to the following.

Education and Training: The AI-driven avatar creation and interaction capabilities may be used to develop educational tools, e.g., wherein historical figures or characters from literature are brought to life as interactive avatars. These avatars may then engage students in immersive learning experiences, answering questions or narrating events from their perspectives.

Healthcare and Therapy: The technology may be adapted to create virtual companions for individuals suffering from loneliness, depression, or cognitive decline. These companions could provide comfort, conversation, and reminiscence therapy, helping users recall and share their life stories, thereby improving their mental health and well-being.

Customer Service: The conversational AI and avatar technology could be implemented in customer service platforms, creating virtual representatives that provide a more personal and engaging user experience. These avatars could assist customers with inquiries, guide them through services, or offer support with a human-like interaction model.

Entertainment and Gaming: In the gaming industry or virtual reality experiences, the invention's capabilities could be used to generate dynamic non-player characters (NPCs) with their own backstories and memories, allowing for deeper interaction and a more immersive gameplay experience.

Professional Training and Simulation: The technology could be employed in professional settings for training and simulations, creating realistic scenarios where trainees interact with avatars representing clients, patients, or colleagues. This would allow for a safe and controlled environment to practice skills, decision-making, and interpersonal communication.

Cultural Preservation: The invention could be utilized for cultural and historical preservation, creating digital avatars of community elders or cultural figures who share stories, traditions, and wisdom. This would help preserve and disseminate cultural heritage for future generations.

The system 10 also may be used to produce a product, device, composition, or other useful item such as, but not limited to, the following:

The invention may be a digital product, specifically an interactive, life-like avatar that encapsulates an individual's personality, memories, and experiences. This digital avatar may serve as a new form of digital legacy, allowing users to preserve and share their life stories in a dynamic and engaging way. Through the use of artificial intelligence, machine learning, and multimedia content (images, voice recordings, text, etc.), the platform synthesizes these inputs into a coherent, interactive avatar. This avatar can be considered a product in itself, offering a novel means for memory preservation, storytelling, and even educational purposes, as it can encapsulate historical, cultural, or personal knowledge to be passed on to future generations.

The invention, centered around the creation of interactive, life-like digital avatars using artificial intelligence, can produce several types of digital products and facilitate various applications:

Digital Avatars: The core product of the invention. These avatars are personalized, interactive representations of users, created from their uploaded images, voice recordings, and personal narratives. These avatars can simulate conversations, display emotions, and share memories or stories, providing a digital continuation of an individual's presence.

Digital Memory Albums: Beyond a simple photo or video compilation, the platform can create dynamic, interactive memory albums. By integrating the user's personal content with the interactive capabilities of their digital avatar, these albums can narrate life stories, explain the context behind photos, or recount memories in the user's synthesized voice, offering a more immersive reminiscence experience.

Educational Tools: The technology could be adapted to create educational avatars, embodying historical figures, scientists, or literary characters. These avatars could interact with students, answering questions, recounting experiences, or explaining concepts in a personalized and engaging manner, thereby enhancing learning experiences.

Therapeutic Aids: Digital avatars could serve as therapeutic tools, especially in mental health care. By embodying personas that patients can relate to or by simulating lost loved ones, these avatars could offer comfort, facilitate closure, or assist in therapy sessions by providing a safe space for expression and interaction.

Virtual Assistants: While not the primary intent, the technology could be reconfigured to produce advanced virtual assistants. These assistants would go beyond executing commands, capable of holding more nuanced conversations, adapting responses based on emotional cues, and providing personalized assistance based on the user's history and preferences.

Entertainment Personalities: Digital avatars could be created as characters for entertainment purposes, such as hosting virtual events, starring in interactive digital content, or even serving as personalized gaming companions, adapting their interactions and storylines based on the player's preferences and actions.

It is understood that any aspects and/or elements of any embodiment of the system 10 may be combined in any way with any aspects and/or elements of any other embodiment of the system 10 to form additional embodiments of the system 10 that are all within the scope of the system 10.

### Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

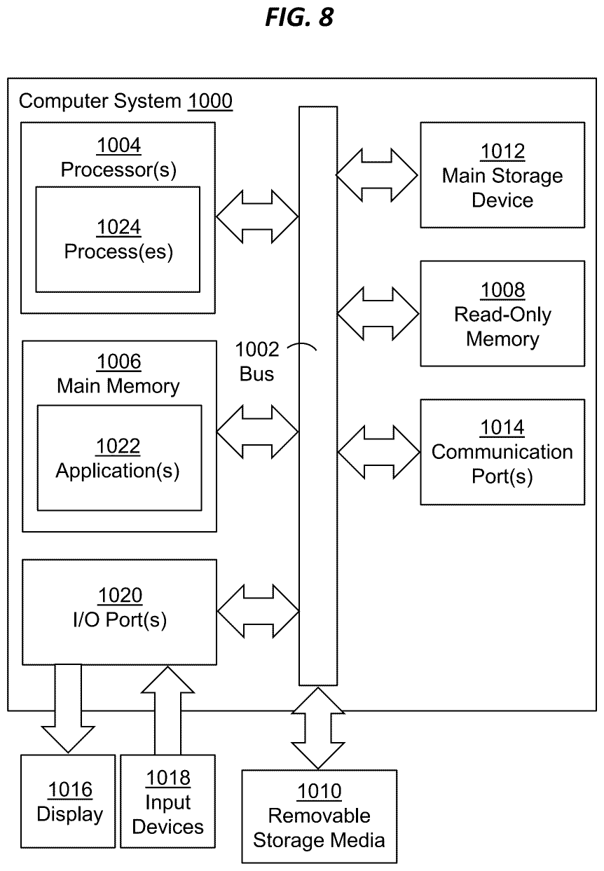

FIG. 8 is a schematic diagram of a computer system 1000 upon which embodiments of the present disclosure may be implemented and carried out.

According to the present example, the computer system 1000 includes a bus 1002 (i.e., interconnect), one or more processors 1004, one or more communications ports 1014, a main memory 1006, removable storage media 1010, read-only memory 1008, and a mass storage 1012. Communication port(s) 1014 may be connected to one or more networks by way of which the computer system 900 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1004 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1014 can be any of an RS-232 port for use with a modem-based dial-up connection, a 10/100 Ethernet port, a Gigabit port using copper or fiber, or a USB port, and the like. Communications port(s) 1014 may be chosen depending on a network such as a Local Area Network (LAN), a Wide Area Network (WAN), a CDN, or any network to which the computer system 1000 connects. The computer system 1000 may be in communication with peripheral devices (e.g., display screen 1016, input device(s) 1018) via Input/Output (I/O) port 1020. Some or all of the peripheral devices may be integrated into the computer system 1000, and the input device(s) 1018 may be integrated into the display screen 1016 (e.g., in the case of a touch screen).

Main memory 1006 can be Random Access Memory (RAM), or any other dynamic storage device(s) commonly known in the art. Read-only memory 1008 can be any static storage device(s) such as Programmable Read-Only Memory (PROM) chips for storing static information such as instructions for processor(s) 1004. Mass storage 1012 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1002 communicatively couples processor(s) 1004 with the other memory, storage, and communications blocks. Bus 1002 can be a PCI/PCI-X, SCSI, a Universal Serial Bus (USB) based system bus (or other) depending on the storage devices used, and the like. Removable storage media 1010 can be any kind of external hard-drives, floppy drives, IOMEGA® Zip Drives, Compact Disc-Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) those program elements that are appropriate to perform the methods.

As shown, main memory 1006 is encoded with application(s) 1022 that support(s) the functionality as discussed herein (an application 1022 may be an application that provides some or all of the functionality of one or more of the mechanisms described herein). Application(s) 1022 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1004 accesses main memory 1006 via the use of bus 1002 in order to launch, run, execute, interpret, or otherwise perform the logic instructions of the application(s) 1022. Execution of application(s) 1022 produces processing functionality of the service(s) or mechanism(s) related to the application(s). In other words, the process(es) 1024 represents one or more portions of the application(s) 1022 performing within or upon the processor(s) 1004 in the computer system 1000.

It should be noted that, in addition to the process(es) 1024 that carries(carry) out operations as discussed herein, other embodiments herein include the application 1022 itself (i.e., the un-executed or non-performing logic instructions and/or data). The application 1022 may be stored on a computer readable medium (e.g., a repository) such as a disk or in an optical medium. According to other embodiments, the application 1022 can also be stored in a memory type system such as in firmware, read only memory (ROM), or, as in this example, as executable code within the main memory 1006 (e.g., within Random Access Memory or RAM). For example, application 1022 may also be stored in removable storage media 1010, read-only memory 1008, and/or mass storage device 1012.

Those skilled in the art will understand that the computer system 1000 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method comprising:
acquiring first data pertaining to a first person;
analyzing at least some of the first data to determine a first personality characteristic of the first person;
generating first training data using the first data and the first personality characteristic of the first person;
training a personality characteristic machine learning model using the first training data;
determining, using the personality characteristic machine learning model, a first response reflecting the first personality characteristic of the first person; and
providing the first response to a user.

2. The method of claim 1 wherein the first data includes at least one of textual data, audio data, and visual data.

3. The method of claim 1 further comprising:
analyzing at least some of the first data to determine a first context relating to a first prior experience of the first person;
wherein the first response reflects the first context.

4. The method of claim 1 further comprising:
receiving, from the user, second data pertaining to the first person;
wherein the second data is provided as a second response from the user in response to the first response.

5. The method of claim 4 further comprising:
adding the second data to the first data to form third data pertaining to the first person;
analyzing at least some of the third data to determine a second personality characteristic of the first person;
modifying the first training data using the third data to create second training data; and
retraining the personality characteristic machine learning model using the second training data.

6. The method of claim 5 further comprising:
determining, using the retrained personality characteristic machine learning model, a third response reflecting the second personality characteristic of the first person, the third response in response to the second response; and
providing the third response to the user.

7. The method of claim 1 wherein the first response includes a first audio response that mimics an audio characteristic of the first person's voice.

8. The method of claim 7 wherein the audio characteristic includes a tone quality of the first person's voice.

9. The method of claim 1 wherein the first response includes a first visual response that mimics a visual characteristic of the first person.

10. The method of claim 9 wherein the visual characteristic includes a visual characteristic of a facial feature of the first person.

11. The method of claim 1 wherein the first response includes a first textual response that mimics a vocabulary characteristic of the first person.

12. A platform-agnostic digital avatar apparatus for electronic communication with a user, the apparatus comprising:
a processor; and
a memory, wherein the memory is electronically and communicatively coupled with the processor and storing instructions configuring the processor to:
acquire first data pertaining to a first person;
extract at least one first person datum from the first data;
determine a personality characteristic from the at least one first person datum, wherein determining the personality characteristic further comprises:
analyzing the at least one first person datum to determine a first personality characteristic;
generating first personality characteristic training data based on the first personality characteristic, wherein the first personality training data comprises correlations between exemplary personality elements which correspond to the first personality characteristic, wherein the first personality characteristic training data is labeled in accordance with the first personality characteristic;
training a personality characteristic machine learning model using the first personality characteristic training data, wherein the model is configured to generate a dynamic response reflecting the determined personality characteristic; and
determining, using the personality characteristic machine learning model, an appropriate natural language response reflecting the first personality characteristic, wherein the response is a function of the personality elements;
modify the first data based on at least one of the first user datum and the first data; and
transmit a first response as a function of the appropriate natural language response and the first personality characteristic to the user.

13. The apparatus of claim 12 wherein the first data includes at least one of textual data, audio data, and visual data.

14. The apparatus of claim 12 wherein the processor is further configured to:
analyze at least some of the first data to determine a first context relating to a first prior experience of the first person;
wherein the first response reflects the first context.

15. The apparatus of claim 12 wherein the processor is further configured to:
receive, from the user, second data pertaining to the first person;
wherein the second data is provided as a second response from the user in response to the first response.

16. The apparatus of claim 15 wherein the processor is further configured to:
add the second data to the first data to form third data pertaining to the first person;
extract at least one second person datum from the third data;
analyze the at least one second person datum to determine a second personality characteristic of the first person;
generate second personality characteristic training data based on the second personality characteristic; and
retrain the personality characteristic machine learning model using the second training data.

17. The apparatus of claim 16 wherein the processor is further configured to:
determine, using the retrained personality characteristic machine learning model, an appropriate natural language response reflecting the second personality characteristic; and
transmit a second response as a function of the appropriate natural language response and the second personality characteristic to the user.
